(19) United States
(12) Patent Application Publication
(10) Pub. No.: US 2009/0090221 A1
(43) Pub. Date: Apr. 9, 2009

(54) Device for Handling Pipes

(76) Inventors: Jens Lutzhoft, Hamburg (DE); Jorn Grotherr, Halstenbek (DE); Ronaldus R.M. Rolling, Hamburg (DE); Iwo Severin, Lubeck (DE)

Correspondence Address: FRIEDRICH KUEFFNER, 317 MADISON AVENUE, SUITE 910, NEW YORK, NY, 10017, US

(21) Appl. No.: 12/226,641

(22) PCT Filed: Feb. 22, 2007
(86) PCT No.: PCT/DE2007/000343

§ 371 Date: Dec. 8, 2008

(30) Foreign Application Priority Data
Apr. 28, 2006 (DE) 10 2006 020 336.4

(51) Int. Cl. B25B 13/50

(52) U.S. Cl. 81/90.3

(57) ABSTRACT

The invention relates to a device for handling pipes, comprising a clamping device (2) carried by a handle (1). The clamping device is configured from at least one spacer element (4) which is pivotally connected to the handle and a clamping jaw support (5) which is pivotally connected to the spacer element. The spacer element and the clamping jaw support are interconnected by an adjustable coupling (15). Said coupling provides at least two different pipe width dimensions for a handling space.

The invention pertains to a device for handling pipes, which comprises a clamping unit carried by a handle, the clamping unit being formed by at least one spacer pivotably connected to the handle and a clamping jaw carrier pivotably connected to the spacer.

These types of devices are typically used for the manual handling of pipes and have a design similar to that of a pipe wrench. The devices make it possible in particular to exert a clamping action on the pipe and to introduce torsional forces into it for the purpose of making screw connections.

It is usually necessary to handle pipes of different sizes with a single basic tool. In the case of the known devices, the clamping jaw carrier is therefore mounted in the clamping unit in such a way that it can be replaced. According to the prior art, a modular system is provided, which consists of a set of clamping jaw carriers of different sizes, which can be used as needed. The insertion and removal of the clamping jaw carriers, however, requires a certain amount of time, which is felt to be disadvantageous. In addition, replacing one component with another has also been found to be especially disadvantageous when the working conditions are harsh.

The object of the present invention is to design a device of the type described above in such a way that it can be easily adapted to pipes of different diameters.

This object is achieved according to the invention in that the spacer and the clamping jaw carrier are connected to each other by a positionable coupling, which provides at least two different pipe width dimensions for a handling space.

As a result of the positionable coupling, only a single, simple adjusting step is required to adapt the width of the device. The positionable coupling makes the device suitable in particular for use in the area of oil well drilling installations, in which drill pipes or other pipes are to be connected to each other. A preferred application is to be found in the area of offshore oil platforms.

The positionable coupling make it possible to adapt the device to the outside diameter of the specific pipe to be handled over a wide range of applications. The outside diameters in question typically range from 2⅜ inch to 7⅝ inch.

A sturdy design is provided in that the coupling has a pin, which is positionable in at least two different recesses in an adapter.

The pipes can be handled more easily if the pin is held by the spacer and the adapter is held by the clamping jaw carrier.

The coupling is designed to provide three different pipe width dimensions so that the design can accommodate different pipe diameters.

It is envisioned in particular that the adapter comprises three recesses for the pin.

The pipe can be clamped more effectively if the adapter is connected pivotably to the spacer by the pin.

A coupling which provides a pivoting joint with respect to the clamping jaw carrier also improves the effectiveness of the clamping.

Another adaptability feature can be obtained by the use of a fitting element to connect the clamping jaw carrier to the handle. The adaptation elements can be accessed easily if the fitting element is located essentially opposite the spacer.

Handling operations can be made even easier by locating a latchable set of teeth in the area of the fitting element to provide at least two different pipe width dimensions for the handling space.

Modular adaptability to typical pipe diameters can be achieved by providing the latchable set of teeth with three latching positions.

The effectiveness with which the pipe can be clamped can be improved even more by connecting the fitting element movably to the handle.

Installing a base sidepiece between the fitting element and the handle provides a high degree of mechanical stability.

If the spacer, the base sidepiece, and the fitting element form the essentially U-shaped boundaries of the handling space, it becomes easier to set the tool down on the pipe to be handled.

Exemplary embodiments of the invention are illustrated in the drawings:

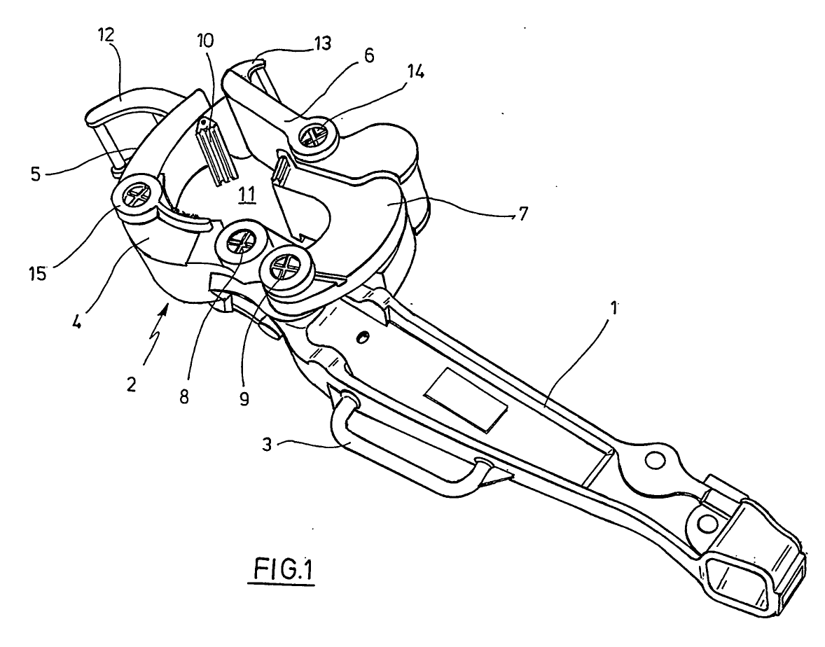

FIG. 1 shows a perspective view of the device for handling pipes with an adaptable clamping unit;

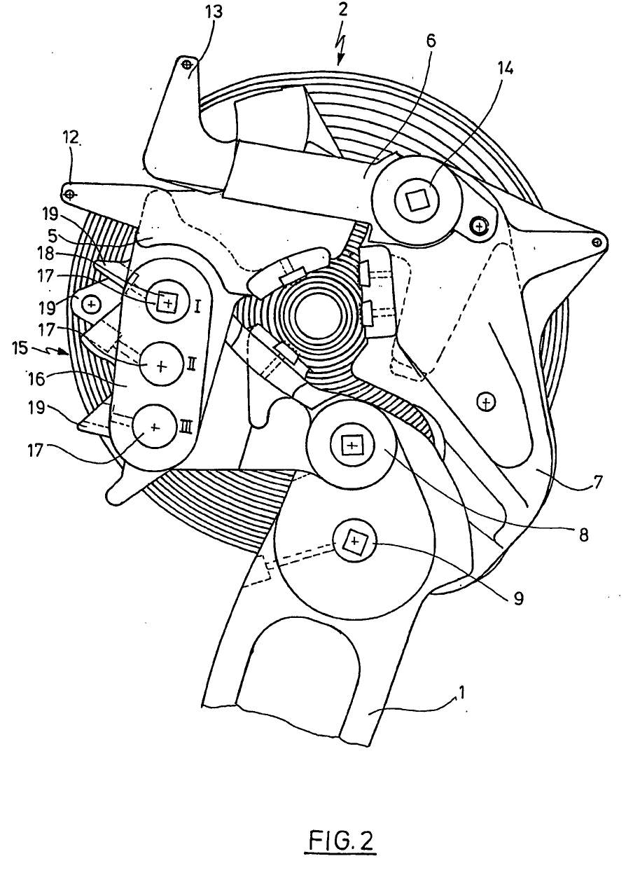

FIG. 2 shows a top view of the clamping unit in an operating state for handling pipe of the smallest diameter;

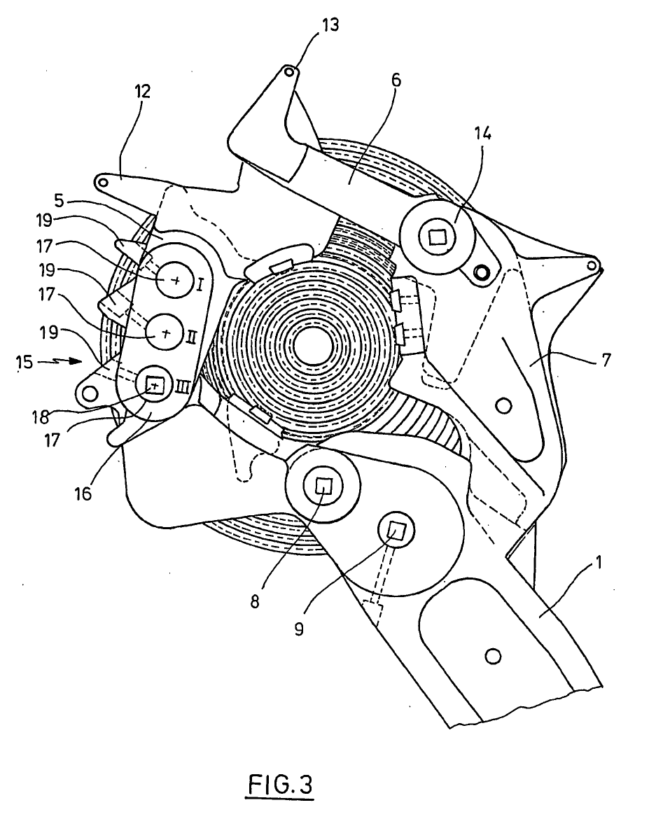

FIG. 3 shows a top view of the clamping unit in an operating state for handling pipe of the largest diameter;

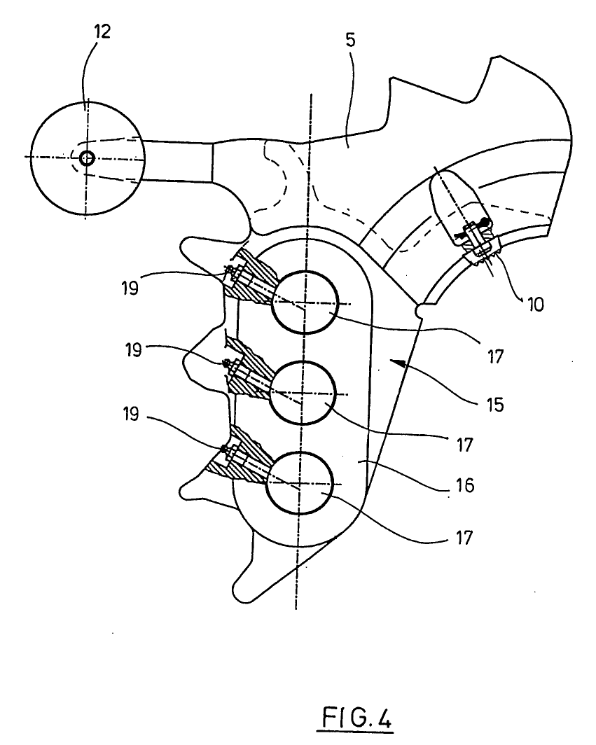

FIG. 4 shows a top view of the device in the area of a pin, which can be placed in any one of three different recesses to implement the width adjustment;

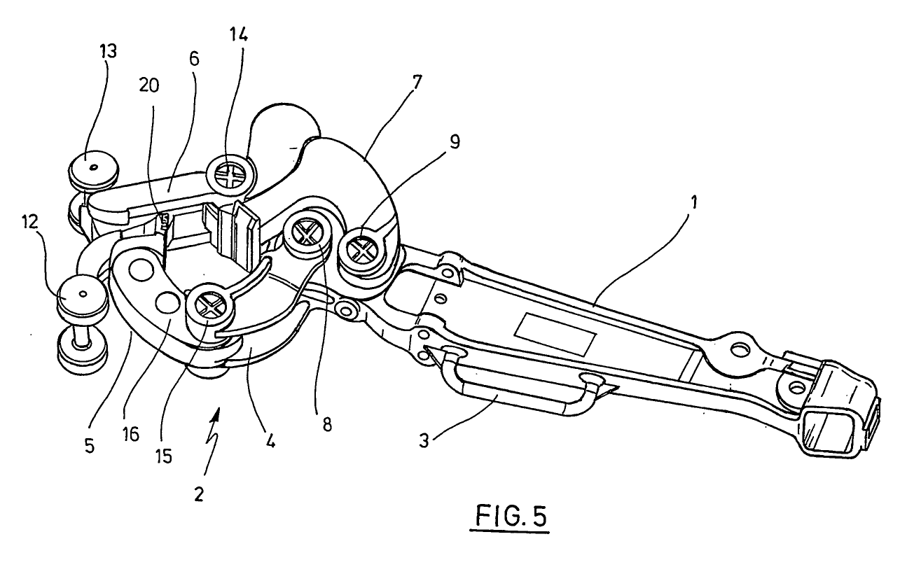

FIG. 5 shows a view similar to that of FIG. 1 of a slightly modified embodiment with a change in the positioning of the components; and

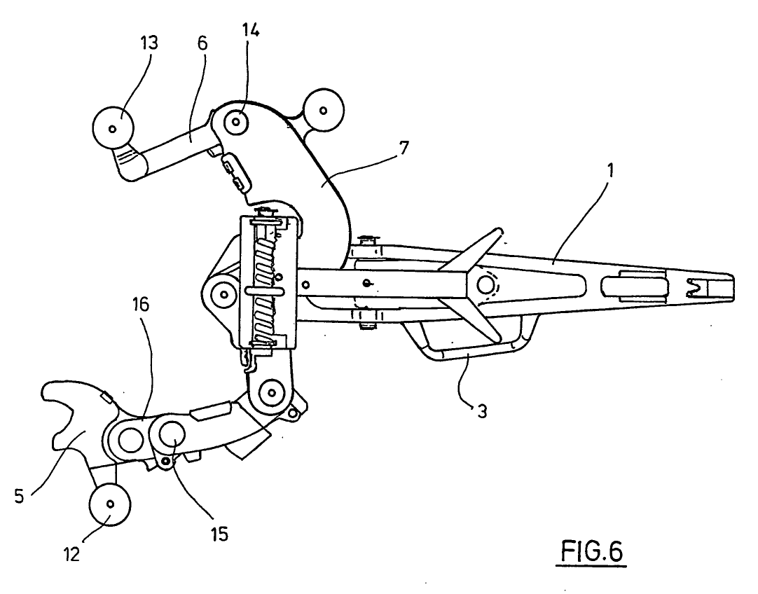

FIG. 6 shows a horizontal cross section through an embodiment representing a modification of the device shown in FIG. 5 with the tool in an open position so that it can be set down on the pipe to be handled.

FIG. 1 shows a wrench-like device for handling pipes, which comprises a handle 1 and a clamping unit 2. The handle 1 is provided for manual handling and is equipped with a hand grip to facilitate transport.

The clamping unit 2 consists essentially of a spacer 4, connected pivotably to the handle 1, a clamping jaw carrier 5, pivotably connected to the spacer 4, a fitting element 6 coupled to the clamping jaw carrier 5, and a base sidepiece 7, also connected to the handle 1. The spacer 4 is coupled to the handle 1 by a pivot joint 8. The base sidepiece 7 is coupled to the handle 1 by a pivot joint 9. To hold the pipe, the clamping jaw carrier 5 comprises a clamping jaw 10, which is arranged to face the handling space 11. Facing away from the clamping jaw 10, the clamping jaw carrier 5 comprises a positioning grip 12. The fitting element 6 is also provided with a positioning grip 13 in the area where it faces away from the handling space 11.

The fitting element 6 is coupled to the base sidepiece 7 by a pivot joint 14. A coupling 15 is used for connecting the clamping jaw carrier 5 to the spacer 4.

FIG. 2 shows the clamping unit 5 in a position suitable for handling a pipe of minimum diameter. In particular, FIG. 2 shows in greater detail the actual design of the coupling 15. It can be seen that the coupling 15 comprises an adapter 16, which is provided with a plurality of recesses 17 and is connected to the clamping jaw carrier 5. The recesses 17 are designed as bores and are arranged in a row. In the exemplary embodiment shown here, one row of three recesses 17 is provided. A pin 18, which is supported by the spacer 4, can be positioned in any one of the recesses 17. The size of the handling space 11 is defined by the selection of the recess 17 assigned to the pin 18. The device is adapted easily by removing the pin 18, placing it in a different recess, and securing the pin 18 in place again. The pin 18 can be secured in place by the use of, for example, clamping element 19. According to the exemplary embodiment shown in FIG. 2, the clamping elements 19 consist of screws.

FIG. 3 shows a variant of the arrangement according to FIG. 2 for handling pipe of the largest possible diameter. The pin 18 here has been relocated from the recess 17 on the right in the drawing to the recess 17 on the left of the drawing. In addition, the fitting element 6 is also involved in the adaptation. In the exemplary embodiment shown here, the fitting element 6 is able to offer three different adaptation positions. Through the combination of the possible variations of the fitting element 6 and the possible variations of the coupling 15, a total of nine different width settings can be defined.

FIG. 4 shows a top view of the design of the coupling 15. The arrangement of the recesses 17 in a row and the positioning of the clamping elements 19 can be seen in particular.

FIG. 5 shows a design variant representing a slight modification of the embodiment shown in FIG. 1. In particular, a latchable set of teeth 20 can be seen in the area of the fitting element 6. This provides the second possibility of adapting the device, in addition to those provided by the coupling 15.

FIG. 6 shows a horizontal cross section through an embodiment representing a slight modification of the device shown in FIG. 5. In the operating state shown here, the clamping jaw carrier and the fitting element 6 have been separated from each other, and the individual components are pivoted to the maximum extent in opposite directions from each other so that the device can be placed onto the pipe to be handled. The coupling 15 is in a central position.

1. A device for handling pipes, which comprises a clamping unit carried by a handle, the clamping unit being formed by a spacer pivotably connected to the handle and by a clamping jaw carrier pivotably connected to the spacer, wherein the spacer (4) and the clamping jaw carrier (5) are connected to each other by a positionable coupling (15), which provides at least two different pipe width dimensions for a handling space (11).

2. A device according to claim 1, wherein the coupling (15) comprises a pin (18), which can be positioned in any one of at least two different recesses (17) in an adapter (16).

3. A device according to claim 1, wherein the pin (18) is held by the spacer (4), and the adapter (16) is held by the clamping jaw carrier (5).

4. A device according to claim 1, wherein the coupling is designed to provide three different pipe width dimensions.

5. A device according to claim 1, wherein the adapter (16) comprises three recesses (17) for the pin (18).

6. A device according to claim 1, wherein the adapter (16) is connected pivotably to the spacer (4) by the pin (18).

7. A device according to claim 1, wherein the coupling (15) provides a pivoting connection with respect to the clamping jaw carrier (5).

8. A device according to claim 1, wherein the clamping jaw carrier (8) is connected to the handle (1) by a fitting element (6).

9. A device according to claim 8, wherein the fitting element (6) is located essentially opposite the spacer (4).

10. A device according to claim 1, wherein, in the area of the fitting element 6, a latchable set of teeth (20) is located to provide at least two different pipe diameter widths for the handling space (11).

11. A device according to claim 10, wherein the latchable set of teeth (20) comprises three latching positions.

12. A device according to claim 1, wherein the fitting element (6) is coupled movably to the handle (1).

13. A device according to claim 1, wherein a base sidepiece (7) is located between the fitting element (6) and the handle (1).

14. A device according to claim 1, wherein the spacer (4), the base sidepiece (7), and the fitting element (6) form the essentially U-shaped boundaries of the handling space (11).
